(19) United States
(12) Patent Application Publication
(10) Pub. No.: US 2026/0094940 A1
(43) Pub. Date: Apr. 2, 2026

(54) BATTERY

(71) Applicant: ZHUHAI COSMX BATTERY CO., LTD., Zhuhai (CN)

(72) Inventors: Qibo Luo, Zhuhai (CN); Qingsong Liu, Zhuhai (CN); Hui Zhu, Zhuhai (CN); Yao Chen, Zhuhai (CN)

(21) Appl. No.: 19/318,323

(22) Filed: Sep. 3, 2025

(30) Foreign Application Priority Data
Sep. 27, 2024 (CN) 202411362571.X

(51) Int. Cl. H01M 50/46; H01M 4/13; H01M 10/052; H01M 10/0567; H01M 10/0568; H01M 10/0569; H01M 10/42; H01M 50/431; H01M 50/449; H01M 50/463; H01M 50/586; H01M 50/59

(52) U.S. Cl. CPC H01M 50/461; H01M 4/13; H01M 10/052; H01M 10/0567; H01M 10/0568; H01M 10/0569; H01M 10/4235; H01M 50/431; H01M 50/449; H01M 50/463; H01M 50/586; H01M 50/59; H01M 2300/004

(57) ABSTRACT

A battery comprises a separator. In the width direction of the separator, the separator further comprises a first region and a second region located between the positive and negative electrode plates. The protruding heights of the adhesive layers in the first and second regions are denoted as X and Y, respectively. The battery further comprises an electrolyte comprising a first solvent and a first additive each having a dielectric constant of ≤10. Based on the total mass of the electrolyte, the mass percentages of the first solvent and the first additive are denoted as a and b, respectively; and 3≤(a+b)/(X/Y)≤60 is satisfied, such that the adhesion between the separator and the electrode plate can be significantly improved, and the infiltration problem caused by the pore blockage by the adhesive layer of the separator can be effectively solved.

### CROSS-REFERENCE TO RELATED APPLICATIONS

The present application claims priority to Chinese Patent Application No. 202411362571.X, titled “BATTERY,” filed on Sep. 27, 2024, the entire contents of which are incorporated herein by reference.

### TECHNICAL FIELD

The present disclosure relates to the technical field of lithium batteries, and in particular relates to a battery.

### BACKGROUND ART

The adhesion between an electrode plate and a separator plays an important role in the performance, safety, cycle life, etc. of lithium ion batteries. to increase the adhesion between the electrode plate and the separator, an adhesive-coated separator is usually selected to increase the adhesion in the prior art. Although the adhesive-coated separator can increase the adhesion between the electrode plate and the separator, after the battery is hot-pressed, the adhesive layer in the adhesive-coated separator will block the pores of the separator, which causes the poor electrolyte infiltration, resulting in problems such as increased DCR of the battery, meanwhile the decrease in the porosity of the separator may also result in the lithium precipitation problem.

### SUMMARY

The object of the present disclosure is to overcome the above-mentioned problems in the prior art by providing a battery, wherein a first solvent and a first additive having a dielectric constant of ≤10 are added to the electrolyte of the battery, and when the mass percentage of the first solvent in the electrolyte, the mass percentage of the first additive in the electrolyte, the protruding height of the adhesive layer in the first region of the separator and the protruding height of the adhesive layer in the second region of the separator satisfy a specific relationship, the adhesion between the separator and the electrode plate can be significantly improved, and the infiltration problem caused by the pore blockage by the adhesive layer of the separator is effectively solved.

To achieve the above object, the present disclosure provides a battery. The battery comprises a positive electrode plate, a separator and a negative electrode plate, which are stacked, wherein the separator comprises a first region, which is a region, exceeding the positive electrode plate, of the separator in the width direction of the separator;
the separator comprises a base film, which is provided with an adhesive layer at least on the side close to the positive electrode plate; in the width direction of the separator, the separator further comprises a second region located between the positive and negative electrode plates; and the protruding height of the adhesive layer in the first region is denoted as X μm, and the protruding height of the adhesive layer in the second region is denoted as Y μm;
the battery further comprises an electrolyte comprising a first solvent having a dielectric constant of ≤10 and a first additive having a dielectric constant of ≤10, wherein based on the total mass of the electrolyte, the mass percentage of the first solvent is denoted as A, and the mass percentage of the first additive is denoted as B; and
X, Y, a and b satisfy: 3≤(a+b)/(X/Y)≤60.

In the present disclosure, the above technical solutions are used and have the following beneficial effects:
the present disclosure provides a battery, wherein a first solvent having a dielectric constant of ≤10 and a first additive having a dielectric constant of ≤10 are added to the electrolyte, and by adjusting the mass percentage (a) of the first solvent in the electrolyte, the mass percentage (b) of the first additive in the electrolyte, the protruding height (X) of the adhesive layer in the first region and the protruding height (Y) of the adhesive layer in the second region to satisfy 3≤(a+b)/(X/Y)≤60, the adhesion between the separator and the electrode plate can be significantly improved, and the electrolyte infiltration problem caused by the pore blockage by the adhesive layer of the separator is effectively solved.

The endpoints of ranges and any values disclosed herein are not limited to such exact ranges or values, and these ranges or values should be understood to include values close to these ranges or values. For numerical value ranges, one or more new numerical value ranges can be obtained between endpoint values of various ranges, between endpoint values of various ranges and individual point values, and between individual point values, and these numerical value ranges should be regarded as specifically disclosed herein. In the present disclosure, unless otherwise specified, all the numerical ranges are inclusive of the endpoints.

### BRIEF DESCRIPTION OF THE DRAWINGS

FIG. 1 is a schematic diagram showing a positional relationship between a separator and an electrode plate, wherein the range denoted by A in FIG. 1 represents the second region of the separator, and the range denoted by B represents the first region of the separator.

FIG. 2 shows a schematic diagram of a portion of an adhesive layer of the separator, wherein the range denoted by X in FIG. 2 is the protruding height of the adhesive layer in the first region, and the range denoted by Y is the protruding height of the adhesive layer in the second region.

FIG. 3 shows a structural schematic diagram of a positive electrode plate, wherein the range denoted by D in FIG. 3 is the width of a ceramic coating layer.

Reference signs: 1—Positive electrode plate; 2—Separator; 3—Negative electrode plate; 4—Adhesive layer in second region; 5—Adhesive layer in first region; 6—Positive electrode tab; 7—Ceramic coating layer.

### DETAILED DESCRIPTION OF EMBODIMENTS

Hereinafter, specific embodiments of the present disclosure will be described in detail. It should be understood that the specific embodiments described herein are only used to illustrate and explain the present disclosure and are not used to limit the present disclosure.

Unless otherwise defined, all scientific and technical terms used in the present disclosure have the same meanings as commonly understood by those skilled in the technical field to which the present disclosure relates.

In the present disclosure, the terms “battery”, “lithium battery”, “lithium ion battery” and “lithium ion secondary battery” all have the same meaning and refer to a lithium ion secondary battery, generally including an electrode assembly (e.g., a positive electrode plate, a negative electrode plate, and a separator), a container (housing) for accommodating the electrode assembly, and an electrolyte.

In the present disclosure, the term “dielectric constant” refers to the ratio of the decreased electric field within a medium to the original applied electric field (in a vacuum) when the medium is subjected to an applied electric field, which generates induced charges weakening the electric field. The dielectric constant is an inherent property of a compound and can be found through reference books, literatures, etc. For example, the dielectric constant of an organic solvent can be found in the Gaussian Manual or the Lange's Handbook of Chemistry. As an embodiment, the method for testing the dielectric constant refers to the standard GB/T 31838.8-2024. As an embodiment, the test steps for the dielectric constant include: (1) preparing a parallel plate capacitor with a certain distance between two parallel plates; (2) injecting an organic solvent to be tested into the parallel plate capacitor to ensure that the capacitor is full of the solvent; (3) connecting a power supply and adjusting the voltage to vary the electric field strength; and (4) measuring and recording a capacitance value at different voltages, wherein the capacitance value is the dielectric constant.

The present disclosure provides a battery. The battery comprises a positive electrode plate, a separator and a negative electrode plate, which are stacked, wherein the separator comprises a first region, which is a region, exceeding the positive electrode plate, of the separator in the width direction of the separator;
the separator comprises a base film, which is provided with an adhesive layer at least on the side close to the positive electrode plate; in the width direction of the separator, the separator further comprises a second region located between the positive and negative electrode plates; and the protruding height of the adhesive layer in the first region is denoted as X μm, and the protruding height of the adhesive layer in the second region is denoted as Y μm;
the battery further comprises an electrolyte comprising a first solvent having a dielectric constant of ≤10 and a first additive having a dielectric constant of ≤10, wherein based on the total mass of the electrolyte, the mass percentage of the first solvent is denoted as A, and the mass percentage of the first additive is denoted as B; and X, Y, a and b satisfy: 3≤(a+b)/(X/Y)≤60.

By way of example, the value of (a+b)/(X/Y) may be, for example, 3, 4, 5, 6, 8, 10, 15, 20, 25, 30, 35, 40, 45, 50, 52, 54, 56, 57, 58, 59, 60, or any point value in a range consisting of two of the above point values.

By way of example, the values of a, b, X, and Y may be set with reference to conventional ranges of values of a, b, X, and Y in the art, provided that the relationship among a, b, X, and Y satisfies 3≤(a+b)/(X/Y)≤60, i.e. within the scope of protection of the present disclosure.

After an adhesive-coated separator is hot pressed, the pores of the base film will be blocked, which will lead to a decrease in the porosity of the entire separator and significantly reduce the infiltration. In order to solve the problem of a decrease in the infiltration of the separator after hot pressing, a first solvent having a dielectric constant of ≤10 is added to the electrolyte in the present disclosure. The lower the dielectric constant, the smaller the viscosity of the first solvent. The first solvent is capable of reducing the viscosity of the electrolyte, and can be compatible with the adhesive layer of the separator due to similar polarity characteristics, thus the infiltration can be faster, and the overall infiltration of the cell can be improved, which is conducive to reducing the direct current resistance (DCR) of the cell. The Addition of a first additive having a dielectric constant of ≤10, as an infiltration aid, to the electrolyte can achieve synergistic effects with the first solvent, and further improve the infiltration. Further, when the mass percentage (a) of the first solvent in the electrolyte, the mass percentage (b) of the first additive in the electrolyte, the protruding height (X) of the adhesive layer in the first region, and the protruding height (Y) of the adhesive layer in the second region satisfy 3≤(a+b)/(X/Y)≤60, with the synergistic effect of the electrolyte and the separator, the adhesion between the separator and the electrode plate is significantly increased, and the infiltration problem due to the pore blockage is also effectively solved, the problems of the larger pore blockage area of the separator, the insufficient infiltration of the electrolyte and the higher DCR of the battery when the value of (a+b)/(X/Y)<3 can be effectively avoided, and the deterioration of the high temperature performance of the battery when the value of (a+b)/(X/Y)>60 can also be avoided.

It should be noted that when calculating the value of the formula (a+b)/(X/Y), a and b are substituted into the formula with the corresponding percentage numerical values, X and Y are substituted into the formula with the numerical values corresponding to the actual protruding heights of the adhesive layers, e.g., if a=60%, b=1%, X=5 μm, and Y=2 μm, (a+b)/(X/Y)=(60+1)/(5/2)=24.4.

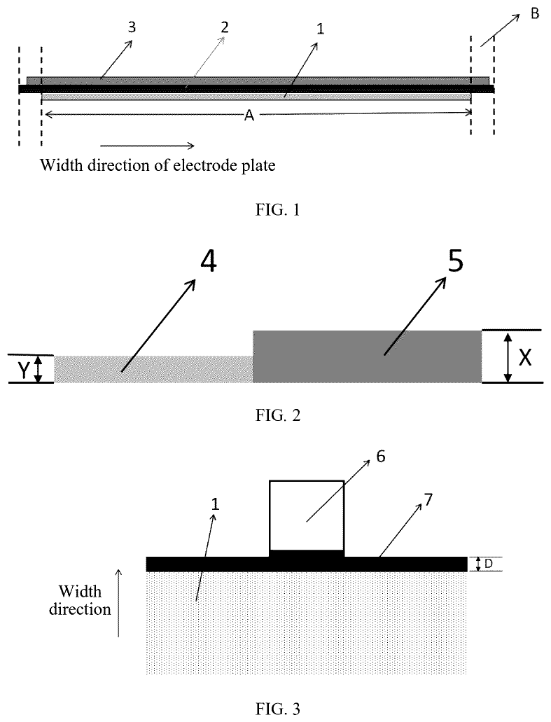

In some embodiments, as shown in FIG. 1, the range denoted by A represents the second region of the separator, and the range denoted by B represents the first region of the separator, that is, the first region can be interpreted as the region, exceeding the positive electrode plate, of the separator.

In some embodiments, as shown in FIG. 2, the thickness range indicated by X is the protruding height of the adhesive layer 5 in the first region, and the thickness range indicated by Y is the protruding height of the adhesive layer 4 in the second region.

In some embodiments, X, Y, a and b satisfy: 7.5≤(a+b)/(X/Y)≤37.5. The value of (a+b)/(X/Y) can be, for example, 7.5, 8, 9, 10, 15, 20, 25, 30, 32, 34, 36, 37.5, or any point value in a range consisting of two of the above point values. When 7.5≤(a+b)/(X/Y)≤37.5 is satisfied, the infiltration of the cell can be further improved, the migration speed of lithium ions can be increased, the DCR can be reduced, and the high-temperature performance of the battery can be improved.

In some embodiments, the protruding height X (μm) of the adhesive layer in the first region satisfies: 0.5≤X≤10. The protruding height X of the adhesive layer in the first region may be, for example, 0.5 μm, 1 μm, 2 μm, 3 μm, 4 μm, 5 μm, 6 μm, 7 μm, 8 μm, 9 μm, 10 μm or any point value in a range consisting of two of the above point values. The protruding height Y (μm) of the adhesive layer in the second region satisfies: 0.2≤Y≤5. The protruding height Y of the adhesive layer in the second region can be, for example, 0.2 μm, 0.5 μm, 1 μm, 2 μm, 3 μm, 4 μm, 5 μm or any point value in a range consisting of two of the above point values. X/Y satisfies: 1.5≤X/Y≤10. The value of X/Y can be, for example, 1.5, 2, 3, 4, 5, 6, 7, 8, 9, 10 or any point value in a range consisting of two of the above point values. Preferably, X/Y satisfies: 2≤X/Y≤6. Due to the design that the negative electrode plate is slightly larger in size than the positive electrode plate, the first region of the separator is subjected to less stress relative to the central region after hot pressing. Under the same hot pressing process, the protruding height X of the adhesive layer in the first region of the separator is higher relative to the protruding height Y of the adhesive layer in the second region, and as the pressure increases, the ratio of X/Y will gradually increase due to the difference in stress. Thus, the magnitude of the X/Y ratio can indicate the spreading extent of the adhesive layer on the base film. The higher the X/Y ratio, the smaller the press fit force on the adhesive layer, that is, the adhesive layer does not spread over a large area on the base film. The lower the height values of X and Y, the larger the area on the base film over which the adhesive layer has spread, which easily causes pore blockage in the separator and reduces the infiltration. When 3≤(a+b)/(X/Y)≤60 is satisfied, the value of X/Y is further adjusted to satisfy the above range, the problems of poorer adhesion between the separator and the electrode plate when X/Y<1.5 and the larger pore blockage area and poorer infiltration when X/Y>10 can be effectively avoided, thus further improving the performance of the battery while taking into account the high adhesion and the high infiltration.

In some embodiments, the sum of the mass percentage of the first solvent and the mass percentage of the first additive based on the total mass fraction of the electrolyte, i.e. a+b (%), satisfies: 30≤a+b≤85. a+b can be, for example, 30%, 35%, 40%, 45%, 50%, 55%, 60%, 65%, 70%, 75%, 80%, 85% or any point value in a range consisting of two of the above point values. Preferably, a+b satisfies: 45≤a+b≤75. When 3≤(a+b)/(X/Y)≤60 is satisfied, and a+b is further adjusted to satisfy the above range, the problems that the electrolyte viscosity is larger, which is not favorable to infiltration, when a+b<30 and the high-temperature performance deteriorates when a+b>85 can be effectively avoided, the DCR of the battery is further reduced and the infiltration of the electrolyte and the high temperature performance of the battery are improved.

In some embodiments, the mass percentage a (%) of the first solvent having a dielectric constant of ≤10 based on the total mass fraction of the electrolyte satisfies: 10≤a≤80. a can be, for example, 10%, 20%, 30%, 40%, 50%, 60%, 70%, 80% or any point value in a range consisting of two of the above point values. Preferably, a satisfies: 30≤a≤70. When a<10, the mass percentage of the first solvent is relatively small, and it can not effectively improve the infiltration and reduce the DCR of the battery, and when a>80, the mass percentage of the first solvent is relatively large, and it is easy to decompose and generate a gas at a high temperature, which will deteriorate the high-temperature performance of the battery. Therefore, when 3≤(a+b)/(X/Y)≤60 is satisfied, and the mass percentage a (%) of the first solvent having a dielectric constant of ≤10 is further adjusted to satisfy the above range, the infiltration can be effectively improved, the DCR of the battery can be reduced and the high-temperature performance of the battery can be optimized.

In some embodiments, the mass percentage b (%) of the first additive having a dielectric constant of ≤10 based on the total mass fraction of the electrolyte satisfies: 0.5≤b≤10. The mass percentage of the first additive can be, for example, 0.5%, 1%, 2%, 3%, 4%, 5%, 6%, 7%, 8%, 9%, 10% or any point value in a range consisting of two of the above point values. Preferably, b satisfies: 1≤b≤5. When 3≤(a+b)/(X/Y)≤60 is satisfied, and the mass percentage b (%) of the first additive is further adjusted to satisfy the above range, the first additive can better play a synergistic role with the first solvent and further improve the infiltration performance, reduce the DCR of the battery and improve the lithium ion transport efficiency; the improvement effect in infiltration is poorer, the DCR of the battery is higher, and the synergistic effect with the first solvent is not significant when the content of the first additive is too small (b<0.5) can be avoided; and the problem that when the content of the first additive is too high (b>10), a defluorination reaction easily occurs, generating hydrogen fluoride and deteriorating the high-temperature cycling performance of the battery can also be avoided.

After hot pressing, the porosity of the adhesive-coated separator decreases, and the passage of lithium ions through the separator narrows, which increases the lithium ion transport resistance, causing the lithium intercalation capacity in the corresponding negative electrode to decrease, and when the negative electrode cannot be intercalated with enough lithium ions, these lithium ions will precipitate out on the surface of the negative electrode to form lithium metal element, which will affect the performance of the battery. To further solve the problem of lithium precipitation in the battery after hot pressing the adhesive-coated separator, the present disclosure further provides: the electrolyte further comprises lithium bis(fluorosulfonyl)imide (LiFSI), based on the total mass of the electrolyte, the mass percentage content of lithium bis(fluorosulfonyl)imide is denoted as c; the electrolyte further comprises lithium hexafluorophosphate (LiPF₆), based on the total mass of the electrolyte, the mass percentage content of lithium hexafluorophosphate is denoted as d; and c and d satisfy: 1.0≤c/15+d/12.5≤ 1.6. The value of c/15+d/12.5 can be, for example, 1, 1.1, 1.2, 1.3, 1.4, 1.5, 1.6 or any point value in a range consisting of two of the above point values.

After researches, the inventors have found that when c/12.5+d/15.0<1.0, the concentration of the lithium salt is low and the conductivity is low, and the migration speed of lithium ions is slow, such that the problem of lithium precipitation cannot be effectively solved; and when c/15+d/12.5>1.6, the viscosity of the electrolyte will increase, which is not conducive to infiltration and will also hinder the migration of lithium ions. When 3≤(a+b)/(X/Y)≤60 is satisfied and 1.0≤c/15+d/12.5≤1.6 is further satisfied, the addition of lithium bis(fluorosulfonyl)imide and lithium hexafluorophosphate to the electrolyte can also further reduce the viscosity of the electrolyte, improve the conductivity, improve the kinetic performance of the entire system, and effectively solve the problem of lithium precipitation after hot pressing the adhesive-coated separator, while improving the infiltration and reducing the DCR of the battery.

In some embodiments, the mass percentage content c of lithium bis(fluorosulfonyl)imide and the mass percentage content d of lithium hexafluorophosphate satisfy: 0.1≤c/d≤3. The value of c/d can be, for example, 0.1, 0.5, 1, 1.5, 2, 2.5, 3 or any point value in a range consisting of two of the above point values. When 3≤(a+b)/(X/Y)≤60 and 1.0≤c/15+d/12.5≤1.6 are satisfied, the ratio of c/d is further adjusted to satisfy the above range, the problem that the viscosity of the electrolyte will not be significantly reduced due to c/d<0.1, that is, too little LiFSI and too much LiPF₆, resulting in poorer effect in kinetics improvements can be further avoided, and that LiPF₆ cannot effectively passivate the current collector and LiFSI will corrode the current collector due to c/d>3, that is, too much LiFSI and too little LiPF₆, resulting in the deterioration in the high temperature performance can also be avoided.

In some embodiments, the mass percentage content c (%) of lithium bis(fluorosulfonyl)imide based on the total mass of the electrolyte satisfies: 1≤c≤20. The mass percentage content c of lithium bis(fluorosulfonyl)imide can be, for example, 1%, 3%, 5%, 7%, 8%, 10%, 12%, 14%, 16%, 18%, 20% or any point value in a range consisting of two of the above point values. Preferably, c satisfies: 35c<10. When c satisfies 1≤c≤20, the viscosity of the electrolyte can be further reduced, the conductivity can be improved, the kinetic performance of the entire system can be improved, and the problem of lithium precipitation can be solved.

In some embodiments, the mass percentage content d (%) of lithium hexafluorophosphate based on the total mass of the electrolyte satisfies: 1≤d≤20. The mass percentage content d of lithium hexafluorophosphate can be, for example, 1%, 3%, 5%, 7%, 8%, 10%, 12%, 14%, 16%, 18%, 20% or any point value in a range consisting of two of the above point values. Preferably, d satisfies: 5≤d≤15. When d satisfies 1<d≤20, the viscosity of the electrolyte can be further reduced, the conductivity can be improved, the kinetic performance of the entire system can be improved, and the problem of lithium precipitation can be solved.

To further dissociate the lithium salt, provide more migratable lithium ions, and improve kinetics, the present disclosure further provides that the electrolyte further comprises a second solvent having a dielectric constant of >10, based on the total mass of the electrolyte, the mass percentage of the second solvent is denoted as m; and m and a satisfy: 0.25≤m/a<1.0. The value of m/a can be, for example, 0.25, 0.3, 0.4, 0.5, 0.6, 0.7, 0.8, 0.9, 0.99 or any point value in a range consisting of two of the above point values. When m and a satisfy 0.25≤m/a<1.0, the deterioration in the high temperature performance of the cell due to m/a<0.25 and the larger electrolyte viscosity, which is not conducive to the cell infiltration, when m/a>1.0 can be effectively avoided and the high temperature performance and kinetics performance can be further improved.

In some embodiments, the mass percentage m (%) of the second solvent based on the total mass of the electrolyte satisfies: 5≤m≤40. The mass percentage of the second solvent can be, for example, 5%, 10%, 15%, 20%, 25%, 30%, 35%, 40% or any point value in a range consisting of two of the above point values. Preferably, m satisfies: 20≤m≤30. When m satisfies 5≤m<40, the kinetics performance of the electrolyte can be further improved.

In some embodiments, the second solvent comprises a cyclic carbonate organic compound having a dielectric constant of >10. By way of example, the cyclic carbonate organic compound may be, for example, one or more of ethylene carbonate (EC, dielectric constant 89.6), fluoroethylene carbonate (FEC, dielectric constant 102), propylene carbonate (PC, dielectric constant 66.1), and butylene carbonate (BC, dielectric constant 55.9). The selection of the above cyclic carbonate organic compounds can further improve the infiltration of the electrolyte and optimize the high temperature performance of the battery.

To further enhance the adhesion between the electrode plate and the separator, the present disclosure further provides: the surface of the base film facing the negative electrode plate is provided with an adhesive layer, the surface of the base film facing the positive electrode plate is provided with an inorganic coating layer, and the surface of the inorganic coating layer away from the base film is provided with an adhesive layer. When 3< (a+b)/(X/Y)≤60 is satisfied, and the above arrangements are further made, the adhesion between the electrode plate and the separator can be further enhanced while ensuring a higher infiltration and a lower DCR.

In some embodiments, the adhesive layer comprises a plurality of adhesive dot zones arranged at intervals, wherein the adhesive dot zones have an average diameter of 50 μm-1000 μm, for example, the average diameter of the adhesive dot zones can be 50 μm, 100 μm, 200 μm, 300 μm, 400 μm, 500 μm, 600 μm, 700 μm, 800 μm, 900 μm, 1000 μm or any point value in a range consisting of two of the above point values. When the average diameter of the adhesive dot zones further satisfies the above range, the pore blockage and infiltration reduction due to the larger spreading after hot pressing can be effectively avoided, and the problems of lower spreading after hot pressing and weak adhesion between the electrode plate and the separator due to the average diameter of the adhesive dot zones being too small can also be avoided, and the adhesion between the electrode plate and the separator can be further improved, while improving the infiltration of the electrolyte, reducing the DCR of the battery, and improving the performance of the battery.

In the present disclosure, the “a plurality of adhesive dot zones arranged at intervals” may be construed as a plurality of identical or different adhesive dot zones being evenly distributed on the surface of a substrate at the same or different intervals. The same or different adhesive spot zones may be embodied in the same or different areas of the adhesive dot zones, the same or different shapes of the adhesive dot zones, the same or different materials used in the adhesive dot zones, etc. Further, the adhesive dot zones may be arranged regularly or irregularly across the entire surface of the adhesive layer.

In the present disclosure, the specific shape of the adhesive dot zones is not defined. By way of example, the specific shape of the adhesive dot zones may be a regular shape or an irregular shape, for example, may be a circle, a triangle, a rectangle, a parallelogram and a regular polygon, all of which are within the scope of protection of the present disclosure.

In the present disclosure, when the adhesive dot zone is non-circular, the diameter of the largest circumscribed circle is defined as the average diameter of the adhesive dot zone.

By way of example, the adhesive dot zone may be formed by conventional spraying or other conventional means.

In some embodiments, the adhesive layer has a coverage area ratio on the inorganic coating layer or base film of 10%-60%, for example, the coverage area ratio can be 10%, 20%, 30%, 40%, 50%, 60%, or any point value in a range consisting of two of the above point values. When 3≤(a+b)/(X/Y)≤60 is satisfied, and the coverage area ratio of the adhesive layer on the inorganic coating layer or the base film further satisfies the above range, the infiltration of the electrolyte can be improved and the DCR of the battery can be reduced while maintaining a higher adhesion between the electrode plate and the separator.

In some embodiments, the adhesive layer comprises organic particles, wherein the organic particles comprise one or more of polyvinylidene fluoride, a vinylidene fluoride-hexafluoropropylene copolymer, a polyacrylic resin, polymethyl acrylate, a butyl acrylate-acrylonitrile copolymer, polyacrylonitrile, an ethylene-acrylic acid copolymer, and poly(ethyl acrylate). In some embodiments, the organic particles have a DV50 of 300 μm-500 μm, the DV50 of the organic particles can be, for example, 300 μm, 350 μm, 400 μm, 450 μm, 500 μm, or any point value in a range consisting of two of the above point values, and/or the organic particles have a DV90 of 100 μm-800 μm, the DV90 of the organic particles can be, for example, 100 μm, 200 μm, 300 μm, 400 μm, 500 μm, 600 μm, 700 μm, 800 μm, 900 μm or any point value in a range consisting of two of the above point values. When the DV50 and/or DV90 of the organic particles further satisfy the above ranges, the problems of the pore blockage when the particle size of the organic particles is too large and the weak adhesion between the electrode plate and the separator when the particle size of the organic particles is too small can be effectively avoided, and the adhesion between the electrode plate and the separator can be further enhanced, and the infiltration of the electrolyte can be improved.

In some embodiments, the first solvent comprises a carbonate organic compound and/or a carboxylate organic compound having a dielectric constant of ≤10. The first solvent comprises one or more of dimethyl carbonate (dielectric constant 3.17), diethyl carbonate (dielectric constant 2.82), ethyl methyl carbonate (dielectric constant 2.9), ethyl acetate (dielectric constant 6.02), methyl acetate (dielectric constant 6.0), propyl acetate (dielectric constant 5.5), methyl propionate (dielectric constant 7.72), propyl formate (dielectric constant 7.16), ethyl formate (dielectric constant 8.5), and methyl formate (dielectric constant 2.9). When 3≤(a+b)/(X/Y)≤60 is satisfied, and the above carbonate and/or carboxylate organic compounds having a dielectric constant of ≤10 are further selected as the first solvent, the viscosity of the electrolyte can be further reduced, the kinetic performance can be improved, the transport of lithium ions can be promoted, the infiltration can be improved and the DCR of the battery can be reduced.

In some embodiments, the first additive comprises fluorobenzene and/or fluoroether compounds.

In some embodiments, the fluorobenzene compound comprises one or more of 1,3,5-trifluorobenzene, 1-fluorobenzene, 1,3-difluorobenzene, and 1,4-difluorobenzene.

In some embodiments, the fluoroether compound comprises one or more of 1,1,2,2-tetrafluoroethyl-2,2,3,3-tetrafluoropropyl ether, 1,1,2,2-tetrafluoroethyl-2,2,2-trifluoroethyl ether, and 2,2,2-trifluoroethyl ether.

When 3≤(a+b)/(X/Y)≤60 is satisfied, the above compounds are further selected as the first additive, which can form a better synergistic effect with the first solvent and improve the lithium ion transport efficiency, further reduce the viscosity of the electrolyte, exhibit compatibility with the adhesive layer due to similar polarity characteristics, and accelerate the infiltration speed.

In some embodiments, the electrolyte further comprises a second additive, which comprises at least one of vinylene carbonate (VC), fluoroethylene carbonate (FEC), ethylene sulfate (DTD), methylene methanedisulfonate (MMDS), succinonitrile (SN), adiponitrile (AND), glutaronitrile (GN), hexanetricarbonitrile (HTCN), ethylene glycol bis(propionitrile) ether (DENE), glycerol tricarbonitrile (TCP), tetravinylsilane (TVS), tris(trimethylsilyl) borate (TMSB), hexamethyldisilazane (HMDS), triphenyl phosphite (TPPi), and pentafluoroethoxy cyclotriphosphazene (PFPN).

To further improve the safety performance of the battery, the present disclosure further provides: The positive electrode plate comprises a positive electrode current collector and positive electrode tabs, at least one of the positive electrode tabs is provided on one side of the positive electrode current collector in the width direction of the positive electrode plate, and the positive electrode plate is provided with a ceramic coating layer at the side in the width direction. When the above arrangements are further made, the occurrence of bur piercing through the separator can be effectively reduced and the risk of short circuit of the battery can be reduced.

In some embodiments, as shown in FIG. 3, the positive electrode plate includes a positive electrode current collector (not shown in the figure) and a positive electrode tab 6, the positive electrode tab 6 is provided on one side of the positive electrode current collector in a width direction of the positive electrode plate, the positive electrode plate is provided with a ceramic coating layer 7 at the side close to the positive electrode tab 6 in the width direction, and the range denoted by D represents the width of the ceramic coating layer 7.

In the present disclosure, the surface of at least one side of the positive electrode current collector is provided with a positive electrode active material layer, and the ceramic coating layer is close to or at least partially overlaps with the positive electrode active material layer.

In some embodiments, the ceramic coating layer has a width D of 1 mm-5 mm, for example, the width of the ceramic coating layer can be 1 mm, 2 mm, 3 mm, 4 mm, 5 mm, or any point value in a range consisting of two of the above point values. When the width of the ceramic coating layer further satisfies the above range, the incomplete coverage of the ceramic coating layer on the edge of the positive electrode plate due to the width of the ceramic coating layer is too small, which easily leads to a short circuit in the battery, can be avoided and the excessive electrode plate occupancy of the ceramic coating layer due to the ceramic coating layer is too wide, which increases the mass of non-active materials in the electrode plate and reduces the energy density of the battery can also be avoided.

In some embodiments, the ceramic coating layer comprises ceramic particles. The ceramic particles are selected from at least one of inorganic metal oxides, inorganic metal nitrides and inorganic metal salts. By way of example, the inorganic metal oxides comprise boehmite, alumina, magnesium oxide, calcium oxide, titanium dioxide, silica and zirconium dioxide. By way of example, the inorganic metal nitrides comprise tungsten nitride, silicon carbide, boron nitride, aluminum nitride, titanium nitride and magnesium nitride. By way of example, the inorganic metal salts comprise barium sulfate, calcium titanate, and barium titanate.

In some embodiments, the ceramic particles have a DV50 of 0.05 μm-3 μm, the value of DV50 can be, for example, 0.05 μm, 0.1 μm, 0.5 μm, 1 μm, 1.5 μm, 2 μm, 2.5 μm, 3 μm or any point value in a range consisting of two of the above point values, and/or the ceramic particles have a DV90 of 0.3 μm-6 μm, the value of DV90 can be, for example, 0.3 μm, 0.6 μm, 1 μm, 2 μm, 3 μm, 4 μm, 5 μm, 6 μm or any point value in a range consisting of two of the above point values. When the DV50 and/or DV90 of the ceramic particles further meet the above ranges, the ceramic particles can be more evenly distributed, forming a smoother and denser ceramic coating layer, further reducing the risk of an internal short-circuit of the battery and improving the safety of the battery.

In some embodiments, the ceramic coating layer further comprises a binder, which may comprise at least one of polyvinylidene fluoride (PVDF), hexafluoroethylene, polytetrafluoroethylene, methacrylate, and styrene-butadiene rubber.

The technical solutions of the embodiments of the present disclosure will be clearly and completely described combined with the embodiments of the present disclosure as below, clearly, the embodiments described are merely a part of the embodiments of the present disclosure rather than all of the embodiments of the present disclosure. On the basis of the embodiments of the disclosure, all the other embodiments obtained by those of ordinary skill in the art without creative efforts fall within the scope of protection of the present disclosure.

The materials, reagents, etc. used in the following examples are all commercially available, unless otherwise specified.

The present disclosure will be described below in detail combined with specific examples, which are intended to understand but not to limit the present disclosure.

The batteries of the examples and comparative examples in the present disclosure were prepared according to the following preparation method, and the differences from Example 1-1 are shown below.

### Example 1-1

### (1) Preparation of Electrolyte

In an argon glove box with a water content of <0.1 ppm and an oxygen content of <0.1 ppm,
ethylene carbonate (EC, dielectric constant 89.6), ethyl methyl carbonate (EMC, dielectric constant 2.9) and dimethyl carbonate (DMC, Dielectric constant 3.17) were mixed until uniform, the fully dried lithium hexafluorophosphate (LiPF₆) was added thereto for stirring and dissolving, the mass of LiPF₆ added being 9% of the total mass of the electrolyte, the fully dried lithium bis(fluorosulfonyl)imide (LiFSI) was then added thereto for stirring and dissolving, the mass of LiFSI added being 6% of the total mass of the electrolyte, 1% of 1-fluorobenzene (FB, dielectric constant 4.7) based on the total mass of the electrolyte was added, and 2.5% of vinylene carbonate (VC), 0.5% of fluoroethylene carbonate (FEC) and 0.5% of ethylene sulfate (DTD) based on the total mass of the electrolyte were also added and stirred until uniform, after passing a physical property test, the electrolyte was obtained. The first solvents of EMC and DMC accounted for 60% of the total mass of the electrolyte, and the mass ratio of the two was 5:2.

### (2) Preparation of Positive Electrode Plate

Lithium iron phosphate LFP, polyvinylidene fluoride and acetylene black were put into a vacuum mixer at a mass ratio of 97:2:1 and N-methylpyrrolidone (NMP) was added and mixed thoroughly under the action of the vacuum mixer until a homogeneous positive electrode slurry with a good fluidity is formed with a solid content of 60 wt %; and the positive electrode slurry was evenly coated on an aluminum foil having a thickness of 13 μm, followed by drying, rolling, slitting, and punching to obtain a positive electrode plate.

A ceramic slurry (ceramic particles of alumina and PVDF, the DV50 of the ceramic particles being 2 μm, and the DV90 thereof being 5 μm) was coated on the current collector close to the positive electrode tab, with the width of the ceramic slurry coated being 1-3 mm.

### (3) Preparation of Negative Electrode Plate

Graphite, styrene-butadiene rubber, sodium carboxymethyl cellulose and acetylene black were put into a vacuum mixer at a mass ratio of 96.5:1.5:1:1, deionized water was added and fully mixed under the action of the vacuum mixer to finally form a homogeneous negative electrode slurry with a good fluidity, with a solid content of 50 wt %; and the negative electrode slurry was evenly coated on a copper foil having a thickness of 4.5 μm, followed by drying, rolling, and die cutting to obtain a negative electrode plate.

### (4) Preparation of Battery

The positive electrode plate obtained in step (2), the negative electrode plate obtained in step (3), and a separator (polyethylene film) with an adhesive layer PVDF (DV50 of organic particles being 400 μm, and DV90 thereof being 500 μm) were combined by winding to obtain a bare cell, which was then placed in an outer packaging foil; and the electrolyte prepared in step (1) was injected into a qualified dried cell, followed by the procedures of leaving to stand under vacuum, encapsulation under vacuum, ageing, formation, second encapsulation, aging, sorting, etc., so as to obtain the battery. The protruding height X of the adhesive layer in the first region and the protruding height Y of the adhesive layer in the second region were shown in Table 1.

### (5) Test of Battery

### (i) DCR Test at 25° C. and 50% SOC

The batteries prepared in the examples and comparative examples were subjected to a high-temperature cycling test at 25° C., and the specific test method was as follows:
a battery was placed in an environment of 25±1° C. and left to stand for 120 min; the battery was discharged at a constant current of 0.5 C to 2.5 V and left to stand for 30 min; the battery was charged at a constant current and constant voltage of 0.5 C to 3.65 V, with the cut-off current being 0.05 C, and left to stand for 30 min; and the battery was discharged at a constant current of 0.5 C to 2.5 V, with the discharge capacity being recorded as C0, and left to stand for 30 min, charged at a constant current and constant voltage of 1.0 C to 3.65 V, with a cut-off current being 0.05 C, and left to stand for 30 min, discharged at 1 C to 50% SOC, that is, C0×(1-50% SOC), and left to stand for 120 min in an environment of 25° C.±1° C., and discharged at 3 C for 10 S (sampling time 100 ms), wherein the end voltage of the standing was recorded as V1, the end voltage of the discharge was recorded as V2, and the actual discharge current was recorded as I, then the calculation formula for DCR at 25° C. and 50% SOC was:

$$DCR = ( V 1 - V 2 ) / I .$$

### (ii) High-Temperature Cycling Test at 45° C.

The batteries prepared in the examples and comparative examples were subjected to a high-temperature cycling test at 45° C., and the specific test method was as follows:
a battery was placed in an environment of 45±1° C., and left to stand for 180 min, discharged at a constant current of 0.5 C to 2.5 V, and left to stand for 30 min, charged at a constant current and constant voltage of 0.5 C to 3.65V, with a cut-off current being 0.05 C, and left to stand for 30 min, discharged at a constant current of 0.5 C to 2.5 V, with the discharge capacity being recorded as C0, and left to stand for 30 min, charged at a constant current and constant voltage of 1.0 C0 to 3.65 V, with a cut-off current being 0.05 C0, and left to stand for 30 min, discharged at a constant current of 1.0 C0 to 2.5 V, when the number of cycles was n, the last discharge capacity was recorded as Cn, and the calculation formula for the nth cycle capacity retention rate was:

$$Capacity retention rate ( \% ) = Cn / C 0 \times 100 \% .$$

(iii) Air Permeability of Separator

The batteries of the Examples and Comparative Examples were disassembled, the separators were removed, and 3 sections of the separator were cut at a distance of 150 mm in the longitudinal direction, the sample size was 100 mm×100 mm if the width of the separators was ≥100 mm; and the sample size was 100 mm×the width of the separator if the width of the separator was <100 mm. The separator was placed in the test head of an air permeability tester suitable for the measurement range for air permeability testing. The average of three measurements was recorded as the air permeability of the separator. The higher the air permeability, the more severe pore blockage by the adhesive layer of the separator.

The example groups 1-3 and comparative examples 1-3 followed example 1-1, and the main differences were shown in Table 1. The mass percentage a of the first solvent in the electrolyte was varied in Example group 1. The mass percentage b of the first additive was varied in Example group 2. The heights of the adhesive layers in the first and second regions of the separator were varied by regulating the thicknesses of the adhesive layers in Example group 3. In Comparative example 1, the mass percentage of the first solvent is relatively small, not satisfying 3≤(a+b)/(X/Y)≤60. In Comparative example 2, the first additive was not added, and in Comparative example 3, the mass percentages of the first solvent and the first additive were adjusted, not satisfying 3≤(a+b)/(X/Y)≤60.

TABLE 1

| | | | | | | | | | High- | |
|---|---|---|---|---|---|---|---|---|---|---|
| | | | | | | | | | temperature | |
| | | | Adhesive | Adhesive | | | | | cycling | |
| | | | layer | layer | | | | | at 45° C. | |
| | First | First | height | height in | | | | | 500 T | |
| | solvent | additive | in first | second | | | | | Capacity | Separator |
| | percentage | percentage | region | region | | | | DCR/ | retention | Air |
| | a % | b % | X/μm | Y/μm | a + b | X/Y | (A + b)/(X/Y) | mΩ | rate/% | permeability/s |
| Example | 60 | 1 | 5 | 2 | 61 | 2.5 | 24.4 | 21.86 | 94.01 | 108.0 |
| 1-1 | | | | | | | | | | |
| Example | 10 | 1 | 5 | 2 | 11 | 2.5 | 4.4 | 30.92 | 91.83 | 106.5 |
| 1-2 | | | | | | | | | | |
| Example | 80 | 1 | 5 | 2 | 81 | 2.5 | 32.4 | 18.39 | 92.75 | 107.1 |
| 1-3 | | | | | | | | | | |
| Example | 8 | 1 | 5 | 2 | 9 | 2.5 | 3.6 | 31.07 | 89.52 | 107.6 |
| 1-4 | | | | | | | | | | |
| Example | 60 | 5 | 5 | 2 | 65 | 2.5 | 26 | 20.16 | 93.49 | 108.3 |
| 2-1 | | | | | | | | | | |
| Example | 60 | 0.5 | 5 | 2 | 60.5 | 2.5 | 24.2 | 23.08 | 93.08 | 107.8 |
| 2-2 | | | | | | | | | | |
| Example | 60 | 10 | 5 | 2 | 70 | 2.5 | 28 | 19.01 | 92.86 | 108.1 |
| 2-3 | | | | | | | | | | |
| Example | 60 | 0.1 | 5 | 2 | 60.1 | 2.5 | 24.04 | 26.55 | 89.78 | 108.9 |
| 2-4 | | | | | | | | | | |
| Example | 60 | 1 | 0.5 | 0.2 | 61 | 2.5 | 24.4 | 28.39 | 92.96 | 156.2 |
| 3-1 | | | | | | | | | | |
| Example | 60 | 1 | 10 | 5 | 61 | 2 | 30.5 | 26.41 | 93.01 | 98.8 |
| 3-2 | | | | | | | | | | |
| Comparative | 5 | 1 | 5 | 2 | 6 | 2.5 | 2.4 | 38.16 | 88.75 | 108.1 |
| example | | | | | | | | | | |
| 1 | | | | | | | | | | |
| Comparative | 60 | / | 5 | 2 | 60 | 2.5 | 24 | 25.32 | 91.80 | 107.4 |
| example | | | | | | | | | | |
| 2 | | | | | | | | | | |
| Comparative | 10 | 0.5 | 5 | 1 | 10.5 | 5 | 2.1 | 40.01 | 87.69 | 170.2 |
| example | | | | | | | | | | |
| 3 | | | | | | | | | | |

Note: “/” indicates that the first additive was not added.

As can be seen from Table 1, in the present disclosure, by adding a first solvent having a dielectric constant of ≤10 and a first additive having a dielectric constant of ≤10 to the electrolyte and adjusting the mass percentage (a) of the first solvent in the electrolyte, the mass percentage (b) of the first additive in the electrolyte, the protruding height (X) of the adhesive layer in the first region and the protruding height (Y) of the adhesive layer in the second region to satisfy 3≤(a+b)/(X/Y)≤60, the adhesion between the separator and the electrode plate can be significantly improved while reducing the DCR of the battery, effectively solving the electrolyte infiltration problem caused by the pore blockage by the adhesive layer of the separator, and the high temperature cycling retention can also be improved, and the air permeability of the separator can be increased.

Example groups 4-5 followed example 1-1, and the main differences were shown in Table 2. The mass percentage c of LIFSI in the electrolyte was varied in Example group 4, wherein Example 4-4 was a case where LIFSI was not added to the electrolyte. In Example group 5, the mass percentage d of LiPF₆ in the electrolyte was varied.

TABLE 2

| | | | | | | High- |
|---|---|---|---|---|---|---|
| | | | | | | temperature |
| | | | | | | cycling at |
| | | | | | | 45° C. |
| | | | | | | 500 T |
| | LIFSI | LiPF₆ | | | | capacity |
| | percentage | percentage | | c/15 + | DCR/ | retention |
| | c % | d % | c/d | d/12.5 | mΩ | rate/% |
| Example | 6 | 9 | 0.68 | 1.12 | 21.86 | 94.01 |
| 1-1 | | | | | | |
| Example | 12 | 9 | 1.33 | 1.52 | 18.28 | 93.51 |
| 4-1 | | | | | | |
| Example | 1 | 9 | 0.11 | 0.79 | 25.34 | 92.74 |
| 4-2 | | | | | | |
| Example | 20 | 5 | 4 | 1.73 | 27.22 | 91.30 |
| 4-3 | | | | | | |
| Example | / | 9 | / | / | 29.24 | 87.35 |
| 4-4 | | | | | | |
| Example | 6 | 15 | 0.4 | 1.60 | 23.02 | 93.39 |
| 5-1 | | | | | | |
| Example | 6 | 1 | 6 | 0.48 | 30.04 | 87.19 |
| 5-2 | | | | | | |

Note: “/” indicates that the corresponding parameter was not tested.

As can be seen from Table 2, when 3≤(a+b)/(X/Y)≤60 was satisfied, and 1.0≤c/15+d/12.5≤1.6 was further satisfied, the addition of lithium bis(fluorosulfonyl)imide (LIFSI) and lithium hexafluorophosphate (LiPF₆) to the electrolyte can further reduce the viscosity of the electrolyte, increase the conductivity, reduce the internal resistance of the battery, and improve the cycling capacity retention rate while improving infiltration and reducing the DCR of the battery.

Example group 6 followed example 1-1, and the main differences were shown in Table 3. In Example group 6, the mass percentage m of the second solvent in the electrolyte was varied.

TABLE 3

| | First | Second | | | High-temperature |
|---|---|---|---|---|---|
| | solvent | solvent | | | cycling at 45° C. |
| | content | content | | DCR/ | 500 T capacity |
| | a % | m % | m/a | mΩ | retention rate/% |
| Example 1-1 | 60 | 20.5 | 0.342 | 21.86 | 94.01 |
| Example 6-1 | 60 | 15.0 | 0.250 | 19.38 | 92.37 |
| Example 6-2 | 60 | 10.0 | 0.167 | 17.06 | 91.83 |

As can be seen from Table 3, when 3≤(a+b)/(X/Y)≤60 was satisfied, m and a further satisfied 0.25≤m/a<1.0, the high temperature performance and the kinetic performance can be effectively improved and the internal resistance of the battery was reduced.

Example group 7 followed example 1-1, and the main differences were shown in Table 4. In Example group 7, the coverage area ratio of the adhesive layer was varied by adjusting the coating layer process.

TABLE 4

| | Adhesive | | High-temperature | |
|---|---|---|---|---|
| | layer | | cycling at 45° C. | Air |
| | coverage area | DCR/ | 500 T capacity | permeability |
| | ratio/% | mΩ | retention rate/% | of separator/s |
| Example 1-1 | 20 | 21.86 | 94.01 | 108.0 |
| Example 7-1 | 10 | 25.12 | 93.18 | 95.6 |
| Example 7-2 | 60 | 30.34 | 92.42 | 178.2 |

As can be seen from Table 4, when 3≤(a+b)/(X/Y)≤60 was satisfied, and the coverage area ratio of the adhesive layer further ranged from 10% to 60%, a higher adhesion between the electrode plate and the separator was ensured, while improving the infiltration of the electrolyte and reducing the DCR of the battery.

It should be noted that, as used herein, terms “comprise”, “include”, or any other variants thereof are intended to encompass a non-exclusive inclusion such that a process, method, article, or device which includes a series of elements not only includes these very elements, but may also include other elements not expressly listed, or also include elements inherent to this process, method, article, or device. Without being subject to further limitations, an element defined by a phrase “including . . . ” does not exclude presence of other identical elements in the process, method, article, or device which includes the element. Furthermore, it should be noted that the scopes of the methods and devices in the embodiments of the present application are not limited to performing functions in the order shown or discussed, but may also include performing functions in a substantially simultaneous manner or in a reverse order depending on the functions involved. For example, the described method may be performed in an order different from that described, and various steps may be added, omitted, or combined. Additionally, features described with reference to some examples may be combined in other examples.

The above descriptions are merely preferred embodiments of the present disclosure but not intended to limit the present disclosure, and any modifications, equivalent replacements, etc. made within the spirit and principle of the present disclosure should be included within the scope of protection of the present disclosure.

What is claimed is:

1. A battery, comprising:
a positive electrode plate;
a separator; and
a negative electrode plate, which are stacked,
wherein the separator comprises a first region, which is a region, exceeding the positive electrode plate, of the separator in a width direction of the separator;
the separator comprises a base film, which is provided with an adhesive layer at least on a side close to the positive electrode plate;
in the width direction of the separator, the separator further comprises a second region located between the positive and negative electrode plates; and
a protruding height of the adhesive layer in the first region is denoted as X μm, and the protruding height of the adhesive layer in the second region is denoted as Y μm;
the battery further comprises an electrolyte comprising a first solvent having a dielectric constant of ≤10 and a first additive having a dielectric constant of ≤10; based on a total mass of the electrolyte, a mass percentage of the first solvent is denoted as A, and a mass percentage of the first additive is denoted as B; and
X, Y, a, and b satisfy: 3≤(a+b)/(X/Y)≤60.

2. The battery according to claim 1, wherein X, Y, a and b satisfy: 7.5≤(a+b)/(X/Y)≤37.5;
preferably, X/Y satisfies: 1.5≤X/Y≤10, more preferably 2≤X/Y≤6;
preferably, X satisfies: 0.5≤X≤10; and/or Y satisfies: 0.2≤Y≤5.

3. The battery according to claim 1, wherein a+b satisfies: 30≤a+b≤85, preferably 45≤a+b≤75;
preferably, a satisfies: 10≤a≤80, more preferably 30≤a≤70;
preferably, b satisfies: 0.5≤b≤10, more preferably 1≤b≤5.

4. The battery according to claim 1, wherein the electrolyte further comprises lithium bis(fluorosulfonyl)imide; based on the total mass of the electrolyte, a mass percentage content of lithium bis(fluorosulfonyl)imide is denoted as c;
the electrolyte further comprises lithium hexafluorophosphate; based on the total mass of the electrolyte, a mass percentage content of lithium hexafluorophosphate is denoted as d; and
c and d satisfy: 1.0≤c/15+d/12.5≤1.6.

5. The battery according to claim 4, wherein c and d satisfy: 0.1≤c/d≤3;
preferably, c satisfies: 1≤c≤20, more preferably 3≤c≤10;
preferably, d satisfies: 1≤d≤20, more preferably 5≤d≤15.

6. The battery according to claim 1, wherein the electrolyte further comprises a second solvent having a dielectric constant of ≥10;
based on the total mass of the electrolyte, a mass percentage of the second solvent is denoted as m; and m and a satisfy: 0.25≤m/a<1.0;
preferably, m satisfies: 5≤m≤40, more preferably 20≤m≤30;
preferably, the second solvent comprises a cyclic carbonate organic compound having a dielectric constant ≥10.

7. The battery according to claim 1, wherein a surface of the base film facing the negative electrode plate is provided with an adhesive layer, a surface of the base film facing the positive electrode plate is provided with an inorganic coating layer, and a surface of the inorganic coating layer away from the base film is provided with an adhesive layer;
preferably, the adhesive layer comprises a plurality of adhesive dot zones arranged at intervals, wherein the adhesive dot zones have an average diameter of 50 μm-1000 μm;
preferably, the adhesive layer has a coverage area ratio of 10% to 60% on the inorganic coating layer or the base film.

8. The battery according to claim 7, wherein the adhesive layer comprises organic particles, wherein the organic particles comprise one or more of polyvinylidene fluoride, a vinylidene fluoride-hexafluoropropylene copolymer, a polyacrylic resin, polymethyl acrylate, a butyl acrylate-acrylonitrile copolymer, polyacrylonitrile, an ethylene-acrylic acid copolymer, and poly(ethyl acrylate);
preferably, the organic particles have a DV50 of 300 μm-500 μm, and/or a DV90 of 100 μm-800 μm.

9. The battery according to claim 1, wherein the first solvent comprises a carbonate organic compound and/or a carboxylate organic compound having a dielectric constant of ≤10;
preferably, the first solvent comprises one or more of dimethyl carbonate, diethyl carbonate, ethyl methyl carbonate, ethyl acetate, methyl acetate, propyl acetate, methyl propionate, propyl formate, ethyl formate, and methyl formate;
preferably, the first additive comprises fluorobenzene compounds and/or fluoroether compounds;
preferably, the fluorobenzene compounds comprise one or more of 1,3,5-trifluorobenzene, 1-fluorobenzene, 1,3-difluorobenzene, and 1,4-difluorobenzene; and/or the fluoroether compounds comprise one or more of 1,1,2,2-tetrafluoroethyl-2,2,3,3-tetrafluoropropyl ether, 1,1,2,2-tetrafluoroethyl-2,2,2-trifluoroethyl ether, and 2,2,2-trifluoroethyl ether.

10. The battery according to claim 1, wherein the positive electrode plate comprises a positive electrode current collector and positive electrode tabs; at least one of the positive electrode tabs is provided on one side of the positive electrode current collector in the width direction of the positive electrode plate, and the positive electrode plate is provided with a ceramic coating layer at the side in the width direction;
preferably, the ceramic coating layer has a width D of 1 mm-5 mm; and
preferably, the ceramic coating layer comprises ceramic particles, which have a DV50 of 0.05μ m-3 μm, and/or a DV90 of 0.3 μm-6 μm.
